(19) United States
(12) Patent Application Publication
(10) Pub. No.: US 2025/0370765 A1
(43) Pub. Date: Dec. 4, 2025

(54) FILE PROCESSING METHOD BASED ON CLOUD APPLICATION, AND ELECTRONIC DEVICE AND STORAGE MEDIUM

(71) Applicant: CLOUD INTELLIGENCE ASSETS HOLDING (SINGAPORE) PRIVATE LIMITED, Lazada One (SG)

(72) Inventors: Yong LIU, Hangzhou (CN); Xiantao ZHANG, Hangzhou (CN); Jinkui REN, Hangzhou (CN)

(21) Appl. No.: 18/852,222

(22) PCT Filed: Mar. 27, 2023
(86) PCT No.: PCT/CN2023/084174

§ 371 Date: Sep. 27, 2024

(30) Foreign Application Priority Data
Mar. 28, 2022 (CN) 202210313350.8

(51) Int. Cl. G06F 9/445; G06F 9/54; G06F 16/787

(52) U.S. Cl. CPC G06F 9/445; G06F 9/546; G06F 16/787

(57) ABSTRACT

Embodiments of the present application provide a file processing method based on a cloud application, an electronic device and a storage medium. The method includes: receiving, by a central service, a file processing request from an operating end; reading file and application association data in accordance with the file processing request, and selecting a target application for a target file, where the file and application association data includes priority information of an application, and the priority information is determined in accordance with user operation event data of a target user; generating application processing information in accordance with the target application and the target file, sending the application processing information to a corresponding unit service to call an application resource of the target application through the unit service to process the target file, generate a video stream of an application processing and feedback the video stream to the operating end.

### CROSS-REFERENCE TO RELATED APPLICATIONS

The present application is a national stage of International Application No. PCT/CN2023/084174, filed on Mar. 27, 2023, which claims priority to Chinese Patent Application No. 202210313350.8, entitled “File Processing Method Based on Cloud Application, Electronic Device and Storage Medium” and filed with the China National Intellectual Property Administration on Mar. 28, 2022. Both of the aforementioned applications are hereby incorporated by reference in their entireties.

### TECHNICAL FIELD

The present application relates to the field of computer technologies and, in particular, to a file processing method based on a cloud application, a file processing apparatus based on a cloud application, an electronic device, and a storage medium.

### BACKGROUND

In the process of opening and processing the file, usually, it is necessary to open the file through an application. For example, for a file of a portable document format (PDF) type, it may be opened through a PDF reader, a browser and other applications.

The existing manner of determining the application for processing the file is usually to bind a default application to a file type in advance, so that the file of this file type may be opened by the default application. For example, a file of the PDF type may be bound to the PDF reader (application), so that for processing the file of the PDF type, the file will be opened by using the PDF reader by default.

However, in adopting the above manner to open the file, only the default application is used to open the file, and the file processing manner is not flexible enough.

### SUMMARY

Embodiments of the present application provide a file processing method based on a cloud application to process a file more flexibly.

Correspondingly, embodiments of the present application further provide a file processing apparatus based on a cloud application, an electronic device, and a storage medium to ensure the implementation and application of the above system.

In order to solve the above problem, an embodiment of the present application discloses a file processing method based on a cloud application, including:
receiving, by a central service, a file processing request from an operating end;
reading file and application association data in accordance with the file processing request, and selecting a target application for a target file, where the file and application association data includes priority information of an application, and the priority information is determined in accordance with user operation event data of a target user;
generating application processing information in accordance with the target application and the target file, sending the application processing information to a corresponding unit service so as to call an application resource of the target application through the unit service to process the target file, generate a video stream of an application processing and feedback the video stream to the operating end.

In an embodiment, the file processing request includes: a file parameter and a user parameter;
where the reading the file and application association data in accordance with the file processing request, and selecting the target application for the target file includes:
reading the file and application association data;
determining a file type of the target file in accordance with the file parameter, and determining a set of applications corresponding to the file type;
determining priority information in accordance with the user parameter;
selecting a target application from the set of applications in accordance with the priority information.

In an embodiment, the method further includes: determining unit affiliation information in accordance with the file processing request, where the unit affiliation information is determined in accordance with a geographical location of a user and/or a file storage location;
selecting the unit service in accordance with the unit affiliation information.

In an embodiment, the determining the unit affiliation information in accordance with the file processing request includes at least one of:
determining the geographical location of the user in accordance with a user parameter, and determining the unit affiliation information in accordance with the geographical location;
determining the storage location of the target file in accordance with the file parameter, and determining the unit affiliation information in accordance with the storage location.

In an embodiment, the method further includes: receiving an application launch failure message, and reselecting a target application in accordance with the application launch failure message.

In an embodiment, the method further includes: acquiring the user operation event data, where the user operation event data includes at least one of: an application that processes a file of a target type, a frequency at which an application processes a file of a target type, and duration for which an application processes a file of a target type;
updating the file and application association data in accordance with the user operation event data.

An embodiment of the present application further discloses a file processing method based on a cloud application, including:
receiving application processing information sent by a central service, where the application processing information indicates a target application and a target file, the target application is determined in accordance with a file processing request and file and application association data, the target file is determined in accordance with the file processing request, and the file processing request is made by an operating end;
acquiring the target file and allocating an application resource to the target application;
processing the target file through the target application and generating a video stream of an application processing;
feeding back the video stream to display, on the operating end, a processing of the target file by the target application.

In an embodiment, the processing the target file through the target application and generating the video stream of the application processing includes:
launching the target application by using the application resource, and opening the target file through the target application;
rendering and acquiring a video of a process of launching the target application and opening the target file, and generating a corresponding video stream.

In an embodiment, after a unit service allocates the application resource to the target application, the method further includes:
if an allocation of the application resource fails, generating an application launch failure message, and sending the application launch failure message to the central service to reselect a target application.

In an embodiment, the method further includes: receiving operation information from the operating end, where the operation information is generated in accordance with a triggered operation event;
responding to the operation information through the target application;
rendering and acquiring a video of the target application responding to the operation information, and generating and feeding back a corresponding video stream.

An embodiment of the present application further discloses a file processing method based on a cloud application, including:
in response to an operation on a target file, generating a file processing request;
sending the file processing request to a central service so that the central service reads file and application association data in accordance with the file processing request, and selects a target application for the target file;
receiving a video stream fed back by a unit service, where the unit service calls an application resource of the target application to process the target file and generates the video stream of an application processing;
rendering and displaying the video stream to display a processing of the target file by the target application.

In an embodiment, the method further includes: acquiring an operation event of a mouse, and generating the operation information in accordance with the operation event;
sending the operation information to the unit service to respond to the operation information through the target application and generate the video stream.

An embodiment of the present application further discloses a file processing method based on a cloud application, including:
generating, by an operating end, a file processing request in response to an operation on a target file; sending the file processing request to a central service;
reading, by the central service, file and application association data in accordance with the file processing request, and selecting a target application for the target file, where the file and application association data is determined in accordance with user operation event data of a target user; generating application processing information in accordance with the target application and the target file, and sending the application processing information to a corresponding unit service;
acquiring, by the unit service, the target file and allocating an application resource to the target application; processing the target file through the target application, and generating a video stream of an application processing; feeding back the video stream;
rendering and displaying, by the operating end, the video stream to display a processing of the target file by the target application.

In an embodiment, the file processing request includes: a file parameter and a user parameter;
the reading the file and application association data in accordance with the file processing request, and selecting the target application for the target file includes:
reading the file and application association data;
determining a file type of the target file in accordance with the file parameter, and determining a set of applications corresponding to the file type;
determining priority information in accordance with the user parameter;
selecting a target application from the set of applications in accordance with the priority information.

In an embodiment, the method further includes: determining unit affiliation information in accordance with the file processing request, where the unit affiliation information is determined in accordance with a geographical location of a user and/or a file storage location;
selecting the unit service in accordance with the unit affiliation information.

In an embodiment, the determining the unit affiliation information in
accordance with the file processing request includes at least one of: determining the geographical location of the user in accordance with a user parameter, and determining the unit affiliation information in accordance with the geographical location;
determining the storage location of the target file in accordance with the file parameter, and determining the unit affiliation information in accordance with the storage location.

In an embodiment, the method further includes: receiving an application launch failure message, and reselecting a target application in accordance with the application launch failure message.

In an embodiment, the method further includes: acquiring the user operation event data, where the user operation event data includes at least one of: an application that processes a file of a target type, a frequency at which an application processes a file of a target type, and duration for which an application processes a file of a target type;
updating the file and application association data in accordance with the user operation event data.

In an embodiment, the processing the target file through the target application and generating the video stream of the application processing includes:
launching the target application by using the application resource, and opening the target file through the target application;
rendering and acquiring a video of a process of launching the target application and opening the target file, and generating a corresponding video stream.

In an embodiment, after a unit service allocates the application resource to the target application, the method further includes:
if an allocation of the application resource fails, generating an application launch failure message, and sending the application launch failure message to the central service to reselect a target application.

In an embodiment, the method further includes: receiving operation information from the operating end, where the operation information is generated in accordance with a triggered operation event;
responding to the operation information through the target application;
rendering and acquiring a video of the target application responding to the operation information, and generating and feeding back a corresponding video stream.

In an embodiment, the method further includes: acquiring an operation event of a mouse, and generating the operation information in accordance with the operation event;
sending the operation information to the unit service to respond to the operation information through the target application and generate the video stream.

An embodiment of the present application further discloses an electronic device, including: a processor; and a memory having executable codes stored thereon, when the executable codes are executed by the processor, the method described in the embodiments of the present application is executed.

An embodiment of the present application further discloses one or more machine readable media having executable codes stored thereon, when the executable codes are executed by a processor, the method described in the embodiments of the present application is executed.

Compared with the prior art, the embodiments of the present application include the following advantages:
in the embodiments of the present application, a central service may receive a file processing request from an operating end, then read file and application association data, and select a target application for a target file. The central service can decide an application that processes a file in accordance with an operation event of a user, then generate application processing information, and send it to a corresponding unit service so as to call an application resource of the target application through the unit service to process the target file, generate a video stream of an application processing and feed the video stream back to the operating end, realizing a processing of the file by a cloud application. Compared with the solution of adopting a default application for processing a file, the solution of the embodiments of the present application can process the file more flexibly.

### BRIEF DESCRIPTION OF DRAWINGS

FIG. 1 is a schematic diagram of an example of processing a file under a cloud service system architecture according to an embodiment of the present application.

FIG. 2 is a schematic interactive diagram of an example of processing a file under a cloud service system architecture according to an embodiment of the present application.

FIG. 3 is a flowchart of steps on a center service side in an embodiment of a file processing method based on a cloud application according to the present application.

FIG. 4 is a flowchart of steps on a unit service side in an embodiment of a file processing method based on a cloud application according to the present application.

FIG. 5 is a flowchart of steps on an operating end side in an embodiment of a file processing method based on a cloud application according to the present application.

FIG. 6 is a schematic structural diagram of an embodiment of a file processing apparatus according to the present application.

FIG. 7 is a schematic structural diagram of another embodiment of a file processing apparatus according to the present application.

FIG. 8 is a schematic structural diagram of another embodiment of a file processing apparatus according to the present application.

FIG. 9 is a schematic structural diagram of an example apparatus provided by an embodiment of the present application.

### DESCRIPTION OF EMBODIMENTS

In order to make the above objectives, features and advantages of the present application more obvious and understandable, the present application will be further illustrated in detail below with reference to the accompanying drawings and specific implementations.

Embodiments of the present application may be applied to the field of a cloud application, where the cloud application is a concept of a cloud computing technology and is manifestation of the cloud computing technology at an application layer. In the field of the cloud application, applications are deployed on a cloud server end, and may be used without installing the application locally on the user equipment. And files processed by cloud applications may also be deployed on the cloud server end, such as in some edge nodes or edge storage devices, so that a processing of files by the application is configured to be implemented in a cloud. The cloud application is an application form where local application software is migrated to the cloud to provide services. Compared with local applications, cloud applications are not limited by a local device, an operating system, and computing power, and may provide a cross-system platform application ecosystem, as well as various heavy-weight software with a high computing power requirement. At the same time, through cloud distribution, users may click and use an application without installation. In addition, “data no landing” can also be achieved, which has high security. Embodiments of the present application may collect user operation event of a user, so as to decide the application providing processing on the file according to the user operation event. In processing this type of the file, a decision may be made in accordance with priority information to perform a file processing through the decided application. Compared with the solution of adopting a default application for processing the file, the solution of the embodiments of the present application can process the file more flexibly.

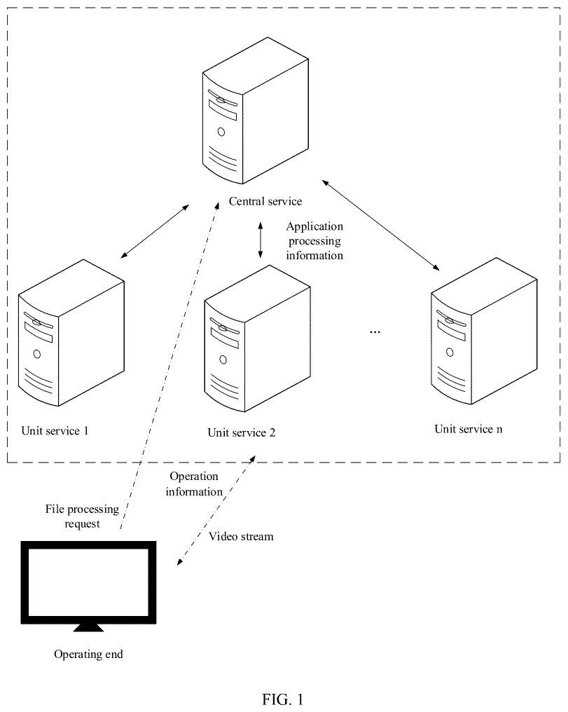

FIG. 1 shows a schematic diagram of an architecture of a cloud service system. The cloud service system includes: an operating end and a cloud server end. The cloud server end may provide an application decision service, a configuration service, a management service and other services. Different services may be deployed in the same or different regions (computer rooms). The application decision service includes a central service, a unit service, etc., where the central service and unit service may be deployed in the same region (computer room) or in different regions (computer rooms). In some examples, the central service and the unit service serve as sub-services of the application decision service, may both be set in a center of the cloud server to provide services. In other examples, the unit service may also be deployed in different regions (computer rooms) to provide services to the user as per regions. The configuration service and the central service may be deployed in the same region (computer room). Various services for cloud files and cloud applications may be provided through the cloud server end. The configuration service is responsible for maintaining file and application association data for a using by the application decision service. The configuration service may provide a manual configuration interface for a tenant administrator to use, and also has an ability of analyzing user operation event data and automatically updating the association data. The application decision service is responsible for reading the file and application association data, and making an application decision on a user's request of opening a file in accordance with the file and application association data. The application decision service is divided into two parts: the central service and the unit service. The central service is responsible for deciding application information, and the unit service tries to allocate an instance resource to the application for users. The file and application association data is data that associates a file with an application, which may determine the application capable of processing the file and provide information for deciding on using the application.

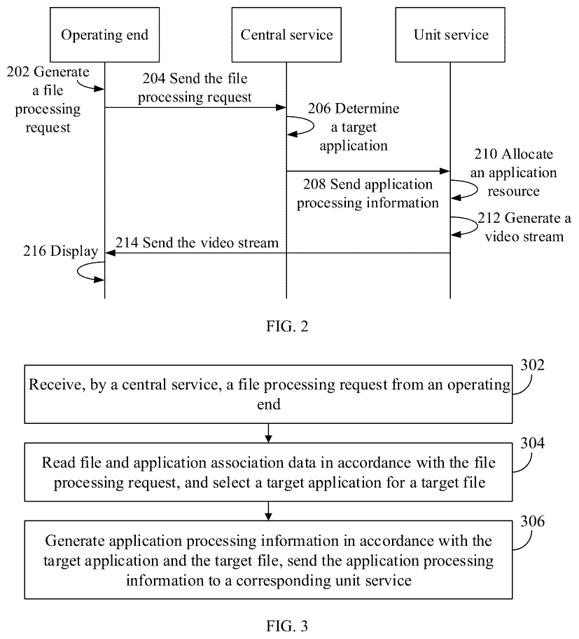

The operating end is a user operating end, which may be carried by various terminal devices, such as a mobile phone, a tablet, a computer and other devices. The user may make a file processing request on the operating end, and the file processing request may be processed by the cloud server. The cloud server decides and allocates a resource for the cloud application, and uses the cloud application to process the file, and then feedback a corresponding video stream to the operating end, so that a process of a target application processing a target file is displayed on the operating end, and the effect thereof is consistent with an effect that can be achieved in a case that the application installed locally on the operating end. The cloud server may use the central service and the unit service to perform the following process: the central service reads the file and application association data based on the sent file processing request, and selects the target application for the target file. Then the central service sends the application processing information to the unit service, such as unit service 2 in the figure. The unit service calls an application resource to process the target file and feeds back the corresponding video stream to the operating end. Specifically, the steps shown in FIG. 2 may be performed.

Step 202, in response to an operation on a target file, the operating end generates a file processing request.

Step 204, the operating end sends the file processing request to a central service.

The operating end may receive an operation performed by a user, for example, a launching operation performed on the target file, or launching, editing, etc. executed in a set manner. The operating end may determine that there is a need to launch a cloud application for processing the target file in accordance with the response to the operation on the target file, so as to generate the file processing request. Then an interface of the cloud application may be called, and the file processing request may be sent to a device where the center service of the cloud server end is located.

Step 206, read file and application association data in accordance with the file processing request, and select a target application for the target file. The file and application association data includes priority information of an application, and the priority information is determined in accordance with user operation event data of the target user.

After the file processing request is received, the target file that needs to be processed may be determined in accordance with the file processing request, and then the file and application association data may be read, the target application for the target file may be determined based on the file and application association data. The file and application association data includes: a set of applications corresponding to a specified file type, the priority information of each of the set of applications, a tenant which each of the set of applications belongs to, and user information of each of the set of applications, etc. Each file type may correspond to one set of applications. Correspondingly, one piece of file and application association data may be configured for the each file type, or sets of applications corresponding to various file types and corresponding priority information may be stored in the file and application association data.

In embodiments of the present application, files may be divided in accordance with the file type. The file type may also be called a file format. The file type refers to an encoding manner of information (picture, text, audio, and other information), and different file types correspond to different encoding manners. For files with different file types, a file may be processed by at least one application. For example, for a file of a target type, there may be multiple related applications capable of processing the file of the target type. In embodiments of the present application, the applications required for files may be automatically decided based on the central service and the unit service, and the configuration unit may provide the file and application association data required for a decision. For the convenience of using by the user, the configuration unit may collect the user operation event data related to the file when configuring the file and application association data, and make a division according to the file type to form the user operation event data that corresponds to different file types.

An embodiment of the present application is described by taking analysis of user operation event related to the file of the target type as an example. Various types of files may be used as the target type to analyze operation event information respectively. The user operation event data related to the file of the target type may include at least one of: the application that processes the file of the target type, a frequency at which the application processes the file of the target type, and duration for which the application processes the file of the target type. After the user operation event data related to the file of the target type is obtained, the user operation event data may be analyzed to determine the priority information of related applications for the target type, so that the target application that processes the file may be decided in accordance with the priority information. In the embodiment of the present application, related applications for the file of the target type can be determined, and the target application can be decided from the related applications. The related applications refer to applications that provide processing of the file of the target type. For different users, in the embodiment of the present application, the priority information of corresponding applications can be analyzed in advance and stored, so that the priority information can be called in a deciding process; the priority information can be updated regularly or updated in response to the user operation event of the user.

In an embodiment, the user operation event data is acquired, and the user operation event data includes at least one of: the application that processes the file of the target type, the frequency at which the application processes the file of the target type, and duration for which the application processes the file of the target type. The file and application association data is updated in accordance with the user operation event data. The user operation event data of each user may be collected respectively and analyzed to form the priority information corresponding to the user, so as to perform a matching in accordance with the user information to obtain the priority information corresponding to the user information, so as to perform a sorting in accordance with the priority information. The priority information may be determined according to the application that processes the file of the target type, a using frequency of the application, using duration of the application and other information selected by the user within a historical time period. The historical time period may be a time period of preset duration before a time corresponding to the file processing request. For example, the time period within three days before the time corresponding to the file processing request may be used as the historical time period; in addition, the historical time period may also be a same time period at which the time period corresponding to the file processing request is located. Specifically, a cycle (such as one day, one week, etc.) may be divided into multiple time periods, and the time period corresponding to the file processing request may be determined, and then the historical time period of the same time period (such as a time period in a previous cycle) may be acquired. In the embodiment of the present application, the application selected by the user within the historical time period for processing the file may be used as an application with a highest priority so as to perform the decision.

In an embodiment of the present application, a frequency at which the user adopts the target application to process the target file may also be collected, and sorting is made in accordance with the frequency at which the application processes the file. In an embodiment of the present application, the usage duration for which the user uses the application may also be collected, and then analysis is performed in accordance with the usage duration. For example, the usage duration after application is launched each time may be recorded. When the usage duration is shorter than preset duration (such as two minutes), this usage may be ignored; when the usage duration exceeds the preset duration, a priority of the application is raised. Furthermore, in an embodiment of the present application, each usage time of the application may also be recorded to determine the priority information in accordance with a usage time and the usage duration of the application. For example, after the user uses application 1 to open file a, the user switches to application 2 to open file a. A service end may determine a switching operation event of the user in accordance with analysis of the usage time and the usage duration of the application, and adjust a priority of application 2 to be higher than a priority of application 1.

In an embodiment, the file processing request includes: a file parameter and a user parameter; the file parameter is a parameter of a required file, such as: a file name, a file type, a file location and other parameters; the user parameter is a parameter for determining a user, such as a user name, a user ID, an IP address of a user, a MAC address and other parameters.

The reading the file and application association data in accordance with the file processing request, and selecting the target application for the target file includes: reading the file and application association data; determining the file type of the target file in accordance with the file parameter, and determining a set of applications corresponding to the file type; determining the priority information in accordance with the user parameter; selecting a target application from the set of applications in accordance with the priority information. The file and application association data may be read, and then the file type of the target file may be determined in accordance with the file parameter, the file and application association data may then be queried based on the file type to determine the set of applications corresponding to the file type, and then the target user may be determined in accordance with the user parameter, the file and application association data may be queried to determine the priority information corresponding to the target user, and the target application may be selected from the set of applications in accordance with the priority information. For example, an application with the highest priority is selected as the target application.

Step 208, generate application processing information in accordance with the target application and target file, and send the application processing information to a corresponding unit service.

After the target application and target file are determined, the application processing information may be generated. The application processing information includes an application parameter of the target application and the file parameter of the target file, such as a name, an identifier, etc. of the application. The file parameter may be such as a file name, a file location, etc. Then the application processing information may be sent to the unit service so that the unit service provides application data to the user.

In an embodiment of the present application, in order to provide users with more efficient services, unit services are usually deployed in multiple locations, so that services can be provided to users based on locations, resources, etc. Therefore, the central service also needs to select the unit service that provides the service to the target user. Unit affiliation information is determined in accordance with the file processing request, and the unit affiliation information is determined in accordance with a geographical location of the user and/or a file storage location; and the unit service is selected in accordance with the unit affiliation information. The determining the unit affiliation information in accordance with the file processing request includes at least one of the following steps: determining the geographical location of the user in accordance with the user parameter, determining the unit affiliation information in accordance with the geographical location; determining the storage location of the target file in accordance with the file parameter, determining the unit affiliation information in accordance with the storage location. The central service may acquire the IP address, the MAC address and other geographical location of the user, the file location and other file storage location from the file processing request as the unit affiliation information, and then select the unit service in accordance with the unit affiliation information. For example, a nearest unit service may be selected in accordance with the geographical location of the user. For another example, the unit service that stores the target file or is relatively nearby may be selected in accordance with the file storage location, or the unit service may be jointly selected by combining the geographical location and the file storage location, etc. The selection of the unit service may also be in accordance with other manners, which is not limited in the embodiments of the present application.

Step 210, acquire the target file and allocate the application resource to the target application.

Step 212, process the target file through the target application and generate a video stream of an application processing.

After acquiring the application processing information, the unit service may acquire the target file and the application resource for the target application based on the application processing information. A software application and a hardware resource may be allocated to launch the target application. The target file may be opened after the target application is launched, and subsequent processing may also be performed based on an operation on the operating end.

In an embodiment, the processing the target file through the target application and generating the video stream of the application processing includes: launching the target application by using the application resource, and opening the target file through the target application; rendering and acquiring a video of a process of launching the target application and opening the target file, and generating the corresponding video stream. The target application may be launched based on the application resource, such as calling the application resource of the target application and instantiating the application resource to launch the target application. The target file is opened through the target application, and during the process of launching the target application opening the target file, a processing process of the target application may be rendered and the corresponding video stream is generated.

In an embodiment of the present application, if an allocation of the application resource fails, an application launch failure message is generated, and the application launch failure message is sent to the central service to reselect a target application. In some other examples, if the central service has sent a suboptimal application, the suboptimal application may be used as the target application and the above process may be re-performed.

After receiving the application launch failure message, the central service reselects a target application in accordance with the application launch failure message. For example, the suboptimal application may be selected as the target application in accordance with the priority information, and then the application processing information may be generated to a processing unit, thereby re-performing a process of allocating the resource to launch the application. In some other examples, the central service may also reselect a processing unit, so as to adopt a new processing unit to perform the above process, which is not limited in the embodiments of the present application.

Step 214, send the video stream to the operating end.

Step 216, render and display the video stream to display a processing of the target file by the target application.

After receiving the video stream, the operating end may render and display it, so that an effect of opening the target application, opening the file in the target application and processing the file is appeared on the operating end. Therefore, the user may perform a processing on the target file, such as editing, based on the target application.

In an embodiment of the present application, an operation event of a mouse is also acquired, and operation information is generated in accordance with the operation event; the operation information is sent to the unit service to respond to the operation information through the target application and generate a video stream. The user may make the operation event through the mouse, touch, etc. for a processing of the file. The operation information may be generated based on the operation event, including an operation manner, an operation location, etc. The operation manner includes, such as single click, double click, long press and other operation manner. The operation location may be coordinate information of a trigger point triggered by, such as mouse or touch.

The unit service receives the operation information from the operating end; responds to the operation information through the target application; renders and acquires a video of the target application responding to the operation information, generates and feeds back the corresponding video stream. The unit service receives the operation information from the operating end and may respond to the operation information through the target application. That is, a corresponding operation, such as, triggering a certain function, that needs to be performed by the target application is determined based on an operation location and manner. The process of the target application responding to the operation information may be rendered, the corresponding video stream may be generated, and sent to the operating end.

In an embodiment of the present application, the video stream may be generated as the processing is performed and sent to the operating end, so that the operating end displays a process as if the application is launched locally and the processing is performed locally.

In summary, the central service may receive the file processing request from the operating end, then read the file and application association data, and select the target application for the target file. The central service can decide the application that processes the file in accordance with the operation event of the user, then generate application processing information, and send it to the corresponding unit service, so as to call the application resource of the target application through the unit service to process the target file, generate the video stream of the application processing and feed it back to the operating end, realizing the processing of the file by the cloud application. Compared with the solution of adopting a default application for processing the file, the solution of the embodiments of the present application can process the file more flexibly.

On the basis of the above embodiments, a file processing method based on a cloud application is provided, which is applied to a central service side of a cloud server and can decide on an application for processing a file, thereby flexibly selecting the required application.

Referring to FIG. 3, a flowchart of steps on the center service side in an embodiment of the file processing method based on the cloud application according to the present application is shown.

Step 302, receive, by a central service, a file processing request from an operating end.

The file processing request includes: a file parameter and a user parameter. User operation event data is acquired, the user operation event data includes at least one of: an application that processes a file of a target type, a frequency at which an application processes a file of a target type, and duration for which an application processes a file of a target type; file and application association data is updated in accordance with the user operation event data.

Step 304, read the file and application association data in accordance with the file processing request, and selecting a target application for a target file. The file and application association data is determined in accordance with the user operation event data of a target user.

The reading the file and application association data in accordance with the file processing request, and selecting the target application for the target file includes: reading the file and application association data; determining a file type of the target file in accordance with the file parameter, and determining a set of applications corresponding to the file type; determining priority information in accordance with the user parameter; selecting a target application from the set of applications in accordance with the priority information.

Step 306, generate application processing information in accordance with the target application and the target file, send the application processing information to a corresponding unit service, so as to call an application resource of the target application through the unit service to process the target file, generate a video stream of an application processing and feedback the video stream to the operating end.

Unit affiliation information is determined in accordance with the file processing request, and the unit affiliation information is determined in accordance with a geographical location of a user and/or a file storage location; the unit service is selected in accordance with the unit affiliation information. The determining the unit affiliation information in accordance with the file processing request includes at least one of the following steps: determining the geographical location of the user in accordance with a user parameter, and determining the unit affiliation information in accordance with the geographical location; determining the storage location of the target file in accordance with the file parameter, and determining the unit affiliation information in accordance with the storage location.

An application launch failure message is received, and a target application is reselected in accordance with the application launch failure message.

On the basis of the above embodiments, a file processing method based on a cloud application is provided, which is applied to a unit service side of a cloud server and can provide a cloud application service based on a decided target application, thereby facilitating a user to use the cloud applications.

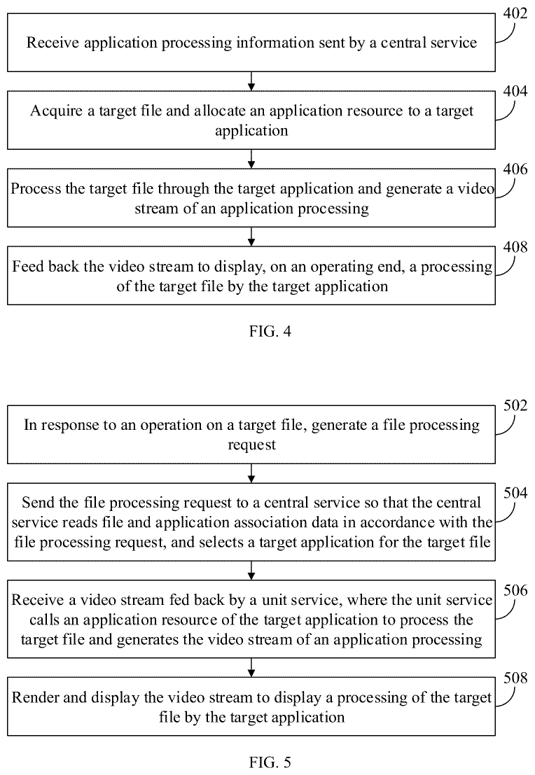

Referring to FIG. 4, a flowchart of steps on the unit service side in an embodiment of the file processing method based on the cloud application according to the present application is shown.

Step 402, receive application processing information sent by a central service.

The application processing information indicates a target application and a target file, the target application is determined in accordance with a file processing request and file and application association data, the target file is determined in accordance with the file processing request, and the file processing request is made by an operating end.

Step 404, acquire the target file and allocate an application resource to the target application.

Step 406, process the target file through the target application and generate a video stream of an application processing.

The processing the target file through the target application and generating the video stream of the application processing includes: launching the target application by using the application resource, and opening the target file through the target application; rendering and acquiring a video of a process of launching the target application and opening the target file, and generating a corresponding video stream.

After the unit service allocates the application resource to the target application, the method further includes: if an allocation of the application resource fails, generating an application launch failure message, and sending the application launch failure message to the central service to reselect a target application.

Step 408, feed back the video stream to display, on the operating end, a processing of the target file by the target application.

The method further includes: receiving operation information from the operating end, the operation information is generated in accordance with a triggered operation event; responding to the operation information through the target application;

rendering and acquiring a video of the target application responding to the operation information, and generating and feeding back a corresponding video stream.

On the basis of the above embodiments, a file processing method based on a cloud application is provided, which is applied to an operating end, such as a user device side. For a target application, a processing may be performed through the cloud application, and a corresponding video data is displayed on the operating end.

Referring to FIG. 5, a flowchart of steps on the operating end in an embodiment of the file processing method based on the cloud application according to the present application is shown.

Step 502, in response to an operation on a target file, generate a file processing request.

Step 504, send the file processing request to a central service so that the central service reads file and application association data in accordance with the file processing request, and selects a target application for a target file.

Step 506, receive a video stream fed back by a unit service, where the unit service calls an application resource of the target application to process the target file and generates the video stream of an application processing.

Step 508, render and display the video stream to display a processing of the target file by the target application.

A triggered operation event may also be acquired, and operation information is generated in accordance with the operation event; the operation information is sent to the unit service to respond to the operation information through the target application and generate the video stream.

Thus a user can use any terminal device to access application software under various platforms or systems provided on a cloud. The target application can be selected automatically and launched based on the target file that needs to be processed, so that the user can conveniently use the cloud application to process the file. There is no need for the user to try among multiple applications, and processing efficiency is improved. In a case that the selected application may fail to open due to an instance resource on the cloud is insufficient, and an automatic switch to other applications can also be performed.

It should be noted that for the sake of description, the method embodiment is expressed as a series of action combinations. However, those skilled in the art should know that the embodiment of the present application are not limited by the described action sequence, because certain steps may be performed in other orders or simultaneously in accordance with the embodiment of the present application. In addition, those skilled in the art should also know that the embodiments described in the specification are all preferred embodiments, and the actions involved are not necessarily be necessary for the embodiments of the present application.

On the basis of the above embodiments, an embodiment further provides a cloud service system, including a central service, a unit service and an operating end. The central service and the unit service may be deployed in a same region (computer room), or even in a same electronic device, or the central service and the unit service may also be deployed in different regions (computer rooms).

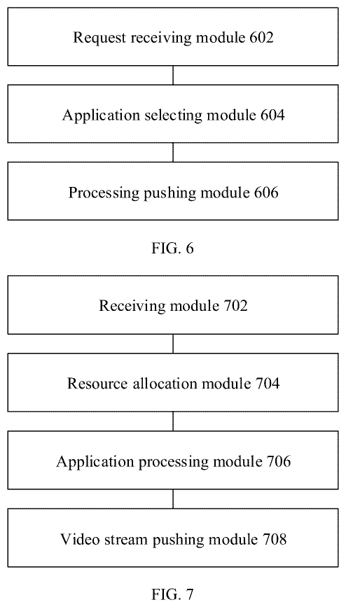

An embodiment further provides a file processing apparatus based on a cloud application, which is applied to an electronic device on a central service side of a cloud server end. Referring to FIG. 6, the apparatus may specifically include the following modules:
a request receiving module 602, configured to receive, by a central service, a file processing request from an operating end;
an application selecting module 604, configured to read file and application association data in accordance with the file processing request, and select a target application for a target file, where the file and application association data is determined in accordance with user operation event data of a target user;
a processing pushing module 606, configured to generate application processing information in accordance with the target application and the target file, send the application processing information to a corresponding unit service, so as to call an application resource of the target application through the unit service to process the target file, generate a video stream of an application processing and feedback the video stream to the operating end.

In summary, the central service may receive the file processing request from the operating end, then read the file and application association data, and select the target application for the target file. The central service can decide the application that processes the file in accordance with the operation event of the user, then generate application processing information, and send it to the corresponding unit service, so as to call the application resource of the target application through the unit service to process the target file, generate the video stream of the application processing and feed it back to the operating end, realizing the processing of the file by the cloud application. Compared with the solution of adopting a default application for processing the file, the solution of the embodiments of the present application can process the file more flexibly.

The file processing request includes: a file parameter and a user parameter; the application selecting module 604 is configured to: read the file and application association data; determine a file type of the target file in accordance with the file parameter, and determine a set of applications corresponding to the file type; determine priority information in accordance with the user parameter; select a target application from the set of applications in accordance with the priority information.

The processing pushing module 606 is further configured to determine unit affiliation information in accordance with the file processing request, where the unit affiliation information is determined in accordance with a geographical location of a user and/or a file storage location; and select the unit service in accordance with the unit affiliation information.

The processing pushing module 606 is configured to determine the geographical location of the user in accordance with a user parameter, and determine the unit affiliation information in accordance with the geographical location; determine the storage location of the target file in accordance with the file parameter, and determine the unit affiliation information in accordance with the storage location.

The application selecting module 604 is further configured to receive an application launch failure message, and reselect a target application in accordance with the application launch failure message.

The apparatus further includes: a configuration module, configured to acquire user operation event data, where the user operation event data includes at least one of: an application that processes a file of a target type, a frequency at which an application processes a file of a target type, and duration for which an application processes a file of a target type; update the file and application association data in accordance with the user operation event data.

On the basis of the above embodiments, an embodiment further provides a file processing apparatus based on a cloud application, which is applied to an electronic device on a unit service side of a cloud server end. Referring to FIG. 7, the apparatus may specifically include the following modules:
a receiving module 702, configured to receive application processing information sent by a central service, where the application processing information indicates a target application and a target file, the target application is determined in accordance with a file processing request and file and application association data, the target file is determined in accordance with the file processing request, and the file processing request is made by an operating end;
a resource allocation module 704, configured to acquire the target file and allocating an application resource to the target application;
an application processing module 706, configured to process the target file through the target application and generate a video stream of an application processing;
a video stream pushing module 708, configured to feed back the video stream to display, on the operating end, a processing of the target file by the target application.

The application processing module 706 is configured to: launch the target application by using the application resource, and open the target file through the target application; render and acquire a video of a process of launching the target application and opening the target file, and generating a corresponding video stream.

The resource allocation module 704 is further configured to: if an allocation of the application resource fails, generate an application launch failure message, and send the application launch failure message to the central service to reselect a target application.

The application processing module 706 is further configured to: receive operation information from the operating end, where the operation information is generated in accordance with a triggered operation event; respond to operation information through the target application; render and acquire a video of the target application responding to the operation information, and generating and feeding back a corresponding video stream.

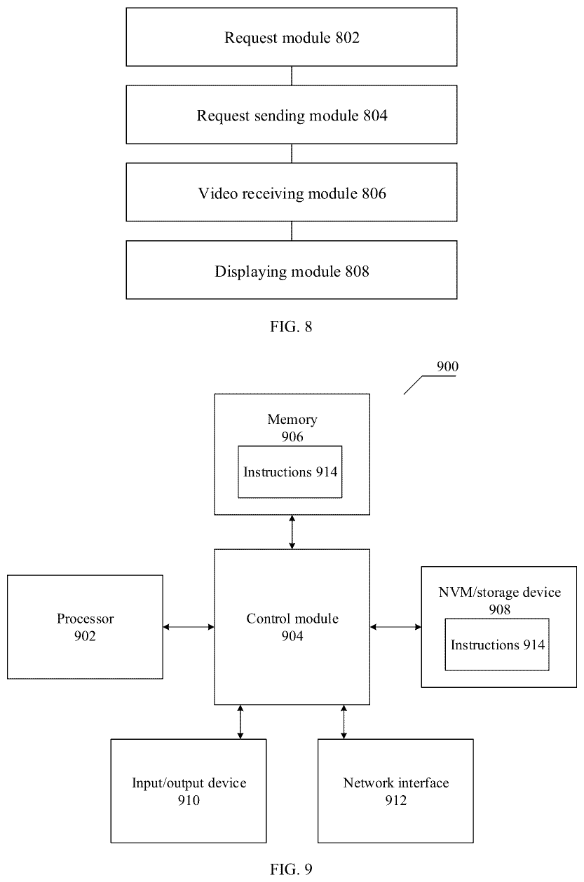

On the basis of the above embodiments, an embodiment further provides a file processing apparatus based on a cloud application, which is applied to an electronic device of an operating end. Referring to FIG. 8, the apparatus may specifically include the following modules:
a request module 802, configured to in response to an operation on a target file, generate a file processing request;
a request sending module 804, configured to send the file processing request to a central service so that the central service reads file and application association data in accordance with the file processing request, and selects a target application for a target file;
a video receiving module 806, configured to receive a video stream fed back by a unit service, where the unit service calls an application resource of the target application to process the target file and generates the video stream of an application processing;
a displaying module 808, configured to render and display the video stream to display a processing of the target file by the target application.

The apparatus further includes: an operating module configured to: acquire a triggered operation event, and generate operation information in accordance with the operation event; send the operation information to the unit service to respond to the operation information through the target application and generate the video stream.

Thus a user can use any terminal device to access application software under various platforms or systems provided on a cloud. The target application can be selected automatically based on the target file that needs to be processed and a file can be launched, so that the user can conveniently use the cloud application to process the file. There is no need for the user to try among multiple applications, and processing efficiency is improved. In a case that the selected application may fail to open due to an instance resource on the cloud is insufficient, and an automatic switch to other applications can also be performed.

An embodiment of the present application further provides a non-volatile readable storage medium, having one or more modules (programs) stored therein, when the one or more modules are applied to a device, the device can be caused to execute instructions of each method step in the embodiments of the present application.

An embodiment of the present application provides one or more machine readable media, having instructions stored thereon, when the instructions are executed by one or more processors, an electronic device is caused to execute the method described in one or more of the above embodiments. In the embodiment of the present application, the electronic device includes a server, a terminal device and other devices. An embodiment of the present application may be implemented as apparatus

using any appropriate hardware, firmware, software, or any combination thereof to perform desired configurations, and the apparatus may include a server (cluster), a terminal and other electronic devices. FIG. 9 schematically illustrates an example apparatus 900 that may be used to implement various embodiments described in the present application.

For an embodiment, FIG. 9 illustrates the example apparatus 900. The apparatus has one or more processors 902, at least one control module (chipset) 904 coupled to at least one of the processor(s) 902, a memory 906 coupled to the control module 904, a non-volatile memory (NVM)/storage device 908 coupled to the control module 904, one or more input/output devices 910 coupled to the control module 904, and a network interface 912 coupled to the control module 904.

The processor 902 may include one or more single-core or multi-core processors, and the processor 902 may include any combination of a general-purpose processor or a special-purpose processor (e.g., a graphics processor, an application processor, a baseband processor, etc.). In some embodiments, the apparatus 900 can serve as a server, a terminal and other devices described in the embodiments of the present application.

In some embodiments, the apparatus 900 may include one or more computer readable media (e.g., the memory 906 or the NVM/storage device 908) having instructions 914 and the one or more processors 902 that are integrated with the one or more computer readable media and configured to execute the instructions 914 to implement the modules, so as to execute the actions described in the present application.

For an embodiment, the control module 904 may include any suitable interface controller to provide any suitable interface to at least one of the (one or more) processor(s) 902 and/or any suitable device or component in communication with the control module 904.

The control module 904 may include a memory controller module to provide an interface to the memory 906. The memory controller module may be a hardware module, a software module, and/or a firmware module.

The memory 906 may be used, for example, to load and store data and/or the instructions 914 for the apparatus 900. For an embodiment, the memory 906 may include any suitable volatile memory, for example, a suitable DRAM. In some embodiments, the memory 906 may include double data rate fourth generation synchronous dynamic random access memory (DDR4SDRAM).

For an embodiment, the control module 904 may include one or more input/output controllers to provide the interface to the NVM/storage device 908 and (one or more) input/output device(s) 910.

For example, the NVM/storage device 908 may be used to store the data and/or the instructions 914. The NVM/storage device 908 may include any suitable non-volatile memory (e.g., flash memory) and/or may include any suitable (one or more) non-volatile storage device(s) (e.g., one or more hard disk drives (HDD), one or more compact disc (CD) drives and/or one or more digital versatile disc (DVD) drives).

The NVM/storage device 908 may include a storage resource that is a part of the device on which the apparatus 900 is installed, or may be accessible by the device without necessarily being a part of the device. For example, the NVM/storage device 908 may be accessed over a network through (one or more) input/output device(s) 910.

The (one or more) input/output device(s) 910 may provide an interface for the apparatus 900 to communicate with any other suitable device, the input/output device 910 may include a communication component, an audio component, a sensor component, and the like. The network interface 912 may provide an interface for the apparatus 900 to communicate over one or more networks, and the apparatus 900 may perform a wireless communication with one or more components in a wireless network according to any standard and/or protocol of one or more wireless network standards and/or protocols, for example, access the wireless network based on a communication standard, such as WiFi, 2G, 3G, 4G, 5G, etc., or a combination thereof for the wireless communication.

For an embodiment, at least one of the (one or more) processor(s) 902 may be packaged with a logic of one or more controllers (e.g., the memory controller module) of the control module 904. For an embodiment, at least one of the (one or more) processor(s) 902 may be packaged together with the logic of the one or more controllers of the control module 904 to form a system-in-package (SiP). For an embodiment, at least one of the (one or more) processor(s) 902 may be integrated on a same mold with the logic of the one or more controllers of the control module 904. For an embodiment, at least one of the (one or more) processor(s) 902 may be integrated on the same mold with the logic of the one or more controllers of the control module 904 to form a system on a chip (SoC).

In various embodiments, the apparatus 900 may be, but is not limited to, a server, a desktop computing device, or a mobile computing device (e.g., a laptop computing device, a handheld computing device, a tablet computer, a netbook, etc.) and other terminal devices. In various embodiments, the apparatus 900 may have more or fewer components and/or different architectures. For example, in some embodiments, the apparatus 900 includes one or more cameras, a keyboard, a liquid crystal display (LCD) screen (including a touch screen display), a non-volatile memory port, a plurality of antennas, a graphics chip, an application specific integrated circuit (ASIC) and a speaker.

A main control chip may be adopted as the processor or control module in a detection apparatus. Sensor data, location information, etc. are stored in the memory or the NVM/storage device. A sensor component may be used as an input/output device, and the communication interface may include a network interface.

An embodiment of the present application further provides an electronic device, including: a processor; and a memory having executable codes stored thereon. When the executable codes are executed, the processor is caused to execute one or more methods described in the embodiments of the present application. In an embodiment of the present application, various data may be stored in the memory, such as a target file, file and application association data, and other various data, and may also include user operation event data, etc., thereby providing a data basis for various processes.

An embodiment of the present application further provides one or more machine readable media, having executable codes stored thereon. When the executable codes are executed, the processor is caused to execute one or more methods of the embodiments of the present application.

As for the apparatus embodiments, since they are basically similar to the method embodiments, the description is relatively simple. For relevant details, please refer to the partial illustration of the method embodiments.

Each embodiment in this specification is described in a progressive manner. Each embodiment focuses on its differences from other embodiments. For the same and similar parts between the various embodiments, reference may be made to each other.

The embodiments of the present application are described with reference to a flowchart and/or a block diagram of the method, the terminal device (system), and a computer program product according to the embodiments of the present application. It will be understood that each flow and/or block in the flowchart and/or the block diagram, and a combination of the flows and/or the blocks in the flowchart and/or the block diagram may be implemented by computer program instructions. These computer program instructions may be provided to a processor of a general-purpose computer, a special-purpose computer, an embedded processor, or other programmable data processing terminal device to produce a machine, so that the instructions executed by the processor of the computer or other programmable data processing terminal device are used to produce an apparatus that implements functions specified in one or more flows in the flowchart and/or one or more blocks in the block diagram.

These computer program instructions may also be stored in a computer readable memory that can guide the computer or other programmable data processing terminal devices to operate in a particular manner, so that the instructions stored in the computer readable memory produce a manufacturing product including an instruction apparatus. The instruction apparatus implements the functions specified in one or more flows in the flowchart and/or one or more blocks in the block diagram.

These computer program instructions may also be loaded onto the computer or other programmable data processing terminal devices, so that a series of operating steps are performed on the computer or other programmable terminal devices to produce a computer-implemented processing, thereby the instructions executed on the computer or other programmable terminal devices provide steps for implementing the functions specified in one or more flows in the flowchart and/or one or more blocks in the block diagram.

Although preferred embodiments of the embodiments of the present application have been described, those skilled in the art may make additional changes and modifications to these embodiments once the basic inventive concepts are understood. Therefore, the appended claims are intended to encompass preferred embodiments as well as all changes and modifications that fall within the scope of the embodiments of the present application.

Finally, it should be noted that in this description, relational terms such as first and second are only used to distinguish one entity or operation from another entity or operation, and do not necessarily require or imply that there is any such actual relationship or order between these entities or operations. Furthermore, the terms “comprise,” “include,” or any other variant thereof are intended to cover a non-exclusive inclusion such that a process, a method, an item, or a terminal device that includes a list of elements includes not only those elements, but also includes other elements that are not explicitly listed, or further includes inherent elements of the process, the method, the item or the terminal device. Without further limitation, the element specified by a statement “include a . . . ” does not exclude the presence of additional identical elements in the process, the method, the item or the terminal device including the element.

A file processing method based on a cloud application, a file processing apparatus based on a cloud application, an electronic device, and a storage medium provided by the present application are introduced in detail above. Specific examples are used in the description to illustrate the principle and the embodiments of the present application; at the same time, for those ordinary skilled in the art, changes will be made in the specific implementation and the application scope in accordance with the ideas in the present application. In summary, the contents of the specification should not be understood as a limitation of the present application.

1. A file processing method based on a cloud application, wherein the method comprises:
receiving, by a central service, a file processing request from an operating end;
reading file and application association data in accordance with the file processing request, and selecting a target application for a target file, wherein the file and application association data is determined in accordance with user operation event data of a target user; and
generating application processing information in accordance with the target application and the target file, sending the application processing information to a corresponding unit service so as to call an application resource of the target application through the unit service to process the target file, generate a video stream of an application processing and feedback the video stream to the operating end.

2. The method according to claim 1, wherein the file processing request comprises: a file parameter and a user parameter;
wherein the reading the file and application association data in accordance with the file processing request, and selecting the target application for the target file comprises:
reading the file and application association data;
determining a file type of the target file in accordance with the file parameter, and determining a set of applications corresponding to the file type;
determining priority information in accordance with the user parameter; and
selecting a target application from the set of applications in accordance with the priority information.

3. The method according to claim 1, further comprising:
determining unit affiliation information in accordance with the file processing request, wherein the unit affiliation information is determined in accordance with a geographical location of a user and/or a file storage location; and
selecting the unit service in accordance with the unit affiliation information.

4. The method according to claim 3, wherein the determining the unit affiliation information in accordance with the file processing request comprises at least one of:
determining the geographical location of the user in accordance with a user parameter, and determining the unit affiliation information in accordance with the geographical location; and
determining the storage location of the target file in accordance with a file parameter, and determining the unit affiliation information in accordance with the storage location.

5. The method according to claim 1, further comprising:
receiving an application launch failure message, and reselecting a target application in accordance with the application launch failure message.

6. The method according to claim 1, further comprising:
acquiring the user operation event data, wherein the user operation event data comprises at least one of: an application that processes a file of a target type, a frequency at which an application processes a file of a target type, and duration for which an application processes a file of a target type; and
updating the file and application association data in accordance with the user operation event data.

7. A file processing method based on a cloud application, wherein the method comprises:
receiving application processing information sent by a central service, wherein the application processing information indicates a target application and a target file, the target application is determined in accordance with a file processing request and file and application association data, the target file is determined in accordance with the file processing request, and the file processing request is made by an operating end;
acquiring the target file and allocating an application resource to the target application;
processing the target file through the target application and generating a video stream of an application processing; and
feeding back the video stream to display, on the operating end, a processing of the target file by the target application.

8. The method according to claim 7, wherein the processing the target file through the target application and generating the video stream of the application processing comprises:
launching the target application by using the application resource, and opening the target file through the target application; and
rendering and acquiring a video of a process of launching the target application and opening the target file, and generating a corresponding video stream.

9. The method according to claim 7, wherein after a unit service allocates the application resource to the target application, the method further comprises:
if an allocation of the application resource fails, generating an application launch failure message, and sending the application launch failure message to the central service to reselect a target application.

10. The method according to claim 7, further comprising:
receiving operation information from the operating end, wherein the operation information is generated in accordance with a triggered operation event;
responding to the operation information through the target application; and
rendering and acquiring a video of the target application responding to the operation information, and generating and feeding back a corresponding video stream.

11. A file processing method based on a cloud application, wherein the method comprises:
in response to an operation on a target file, generating a file processing request;
sending the file processing request to a central service so that the central service reads file and application association data in accordance with the file processing request, and selects a target application for the target file;
receiving a video stream fed back by a unit service, wherein the unit service calls an application resource of the target application to process the target file and generates the video stream of an application processing; and
rendering and displaying the video stream to display a processing of the target file by the target application.

12. The method according to claim 11, further comprising:
acquiring a triggered operation event, and generating operation information in accordance with the operation event; and
sending the operation information to the unit service to respond to the operation information through the target application and generate the video stream.

13. (canceled)

14. One or more non-transitory machine readable media having executable codes stored thereon, wherein when the executable codes are executed by a processor, the method according to claim 1 is executed.

15. One or more non-transitory machine readable media having executable codes stored thereon, wherein when the executable codes are executed by a processor, the method according to claim 7 is executed.

16. One or more non-transitory machine readable media having executable codes stored thereon, wherein when the executable codes are executed by a processor, the method according to claim 11 is executed.

17. An electronic device, including: a processor; and a memory having executable codes stored thereon, when the executable codes are executed by the processor, the method according to claim 1 is executed.

18. The electronic device according to claim 17, wherein the file processing request comprises: a file parameter and a user parameter;
wherein the processor is configured to:
read the file and application association data;
determine a file type of the target file in accordance with the file parameter, and determine a set of applications corresponding to the file type;
determine priority information in accordance with the user parameter; and
select a target application from the set of applications in accordance with the priority information.

19. The electronic device according to claim 17, wherein the processor is further configured to:
determine unit affiliation information in accordance with the file processing request, wherein the unit affiliation information is determined in accordance with a geographical location of a user and/or a file storage location; and
select the unit service in accordance with the unit affiliation information.

20. An electronic device, including: a processor; and a memory having executable codes stored thereon, when the executable codes are executed by the processor, the method according to claim 7 is executed.

21. An electronic device, including: a processor; and a memory having executable codes stored thereon, when the executable codes are executed by the processor, the method according to claim 11 is executed.
